(19) United States
(12) Patent Application Publication
(10) Pub. No.: US 2011/0190090 A1
(43) Pub. Date: Aug. 4, 2011

(54) Eccentric Differential Drive

(75) Inventors: Wolfgang Freund, Langenbernsdorf (DE); Andreas Kissler, Glauchau (DE); Juergen Schulze, Chemnitz (DE); Tino Schmidt, Muelsen (DE)

(73) Assignee: asturia Automotive Systems AG, Munich (DE)

(21) Appl. No.: 13/124,824

(22) PCT Filed: Oct. 19, 2009
(86) PCT No.: PCT/DE2009/001481

§ 371 Date: Apr. 18, 2011

(30) Foreign Application Priority Data
Oct. 19, 2008 (DE) 20 2008 013 633.4

(51) Int. Cl. F16H 1/32; F16H 48/06

(52) U.S. Cl. 475/162

(57) ABSTRACT

An eccentric differential drive having two output elements (3, 4) that can rotate relative to each other, in which a tumble gear (1) which can be driven by a drive element (2) and which has two external tooth sets (z1, z2) with different pitch diameters, the first output element (3) being associated with the first external tooth set (z1) and having a first internal tooth set (z3) corresponding to the first external tooth set (z1), and the second output element (4) being associated with the second external tooth set (z2) and having a second internal tooth set (z4) corresponding to the second external tooth set (z2), and in which the outputs of the first and second output elements (3, 4) are arranged opposite from the drive element (2) and are rotatably mounted on a common second longitudinal axis (A2), which second axis is arranged eccentrically to the first longitudinal axis (A1) of the tumble gear (1), and in which the rotational speed of the outputs (3, 4) varies depending on the applied rotational torque.

The invention relates to an eccentric differential gearbox according to the preamble of the first claim, which is used, for example, for transmitting torque between two elements which are rotatable/pivotable relative to one another or for converting rotary movements of two elements relative to one another into an axial movement of a component.

DE 197 34 536 C2 discloses an eccentric gearbox for a vehicle seat adjusting mechanism, wherein an eccentric driven by an input drive pinion and linked to a planetary gear, and a hollow output gear which is connected to an output shaft and meshes with the planetary gear, are mounted in a gearbox housing, wherein the planetary gear comprises, in two axially offset planes, an input drive gear in engagement with the hollow output gear, and a support gear in engagement with a hollow support gear fixed to the housing and the hollow support gear is integrated into a gearbox cover connected to the gearbox housing.

DE 3226714 C2 discloses that a hinge fitting for a seat wherein a fixed hinge part assigned to the seat and a pivotable hinge part assigned to the seat back are connected to one another via a pivot axis by means of an eccentric, and a first hinge part has an internal tooth set over which part of an external tooth set of the second hinge part forming part of an eccentric gearbox runs. Provided on the first hinge part, arranged concentrically with the internal tooth set thereof, but smaller in diameter and offset in the axial direction, is an internal tooth set which meshes with the second external tooth set arranged concentrically with the external tooth set on the second hinge part, and also offset in the axial direction, wherein the pitch angles of the tooth sets of each hinge part are equal. The second external tooth set is twistably connected to the first external tooth set. For this purpose, one external tooth set is arranged slightly twisted relative to the other external tooth set and the second external tooth set is mounted on a concentric shoulder in the center of the first external tooth set. The twist angle of the first external tooth set and the second external tooth set relative to one another is limited by stops.

The two above solutions are not usable for an anti-roll bar of a vehicle and it is also not possible with these to convert a relative rotation movement of two components into an axial movement of a further element.

WO 01/51301 A1 discloses the use of an electromechanical anti-roll bar for the chassis of a vehicle, particularly a motor vehicle, having an actuator linked between two anti-roll bar halves and twisting said halves relative to one another through a twist angle if needed, said actuator comprising an electric motor and a gearbox connected thereafter. Herein, the gearbox has a gearing ratio which changes depending on the twist angle. For example, the gearbox having a variable gearing ratio can be configured as a hypocycloid gearbox with linear guides or as an eccentric gearbox. The hypocycloid gearbox comprises a sun gear with an input drive shaft and the planet gears have eccentrically arranged pegs and are guided by the hollow gear which is non-rotatably connected to one of the two anti-roll bar halves. The output element of said hypocycloid gearbox is non-rotatably connected to the other anti-roll bar half and, in said gearbox, as many sliding block guides are provided as there are planet gears present. A sliding block, which has a receptacle for a peg of the associated planet gear, is mounted in each of the sliding block guides. In the eccentric gearbox a sun gear is also provided, the input drive shaft of which is connected to the electric motor optionally via the further gearbox stage with a constant gearing ratio. The planet gears have eccentrically arranged pegs, wherein the rotation axes of the planet gears are brought together to one shaft journal which is non-rotatably connected to the other anti-roll bar half. The output element of this eccentric gearbox is connected to the other anti-roll bar half. A sliding block, which has a receptacle for a peg of the associated planet gear, is mounted in each of the sliding block guides.

This solution is very complex and occupies a large volume.

DE 10 2007 011 615 A1 discloses a vehicle height adjustment making use of two rotors, wherein a height adjustment of a spring is realized by means of a screw thread in order to bring about leveling of the vehicle. With this solution, a high starting rotary speed is required for a relatively small stroke movement. The system operates relatively slowly and, due to the high friction caused by the gearbox, has an unfavorable level of efficiency.

DE 10 2006 046 949 A1 discloses an actuator for actuating two organs by means of traction forces, comprising a drivable eccentric shaft and two hollow gears arranged rotatable about the eccentric shaft, to which suitable traction means can be attached for actuating the organs. The actuator additionally comprises a toothed element rotatably mounted on the eccentricity of the eccentric shaft, said toothed element having two toothed zones of different size which mesh with the hollow gears. For acoustic decoupling, the toothed element is mounted on the eccentric shaft by means of two angular contact rolling bearings, the radial planes of which intersect. One output gear is arranged on the input drive side of the eccentric shaft and the other output gear is arranged on the opposite side, wherein both output gears are mounted on the eccentric shaft and are driven via the toothed element. Four toothed gear pairings are therefore required and these are arranged one after the other in the axial direction, so that a large amount of space is required. The use of additional hollow gears and angular contact rolling bearings makes the design relatively complex.

DE 102 22 339 A1 discloses clutch and gear shift actuators which serve to control a clutch or a gear shift mechanism of a motor vehicle. A double pinion is used, which is fastened eccentrically on the output shaft and is fastened for rotation relative thereto. However, this solution does not provide two outputs that are rotatable relative to the input drive. DE 199 37 412 A1 and DE 197 22 399 A1 disclose cycloid gearboxes which have no toothing and operate according to another principle.

EP 1 627 757 A1 discloses an anti-roll bar arrangement wherein, however, no input drive element with different tooth sets is used and two output drives opposite to the input drive side are not provided.

U.S. Pat. No. 4,016,780 discloses a gearbox which has an input shaft which, by means of a driving piece, drives an eccentric and an eccentric gear having two tooth sets, by means of which a housing and an output shaft are rotatable relative to one another. The housing is supported on the input shaft. Due to the driving piece which has a relatively small cross-section, the risk of breakage caused by large forces exists.

JP 2007 162758 A discloses a pivot motor wherein a hollow gear with two tooth sets is also driven via an eccentric. However, two mutually opposing outputs which are twistable relative to one another are provided.

US 2008/0150241 A1 also discloses an anti-roll bar system. This has an input drive motor placed radially outwardly with, arranged on the motor shaft, a toothed gear having external toothing. This input drive pinion drives two mutually opposing output shafts via a plurality of mutually meshing hollow gears which have corresponding toothing and are mounted eccentrically to one another and are rotatable relative to one another.

WO 2008/049382 A1 discloses a solution wherein the input drive is not carried out with an eccentric. It is also not possible with the previous solution or this solution to provide two output drives opposing the input drive side.

It is an object of the invention to develop an eccentric differential gearbox, particularly for vehicles, wherein two ring-shaped output elements are provided which are arranged rotatable relative to the input drive and relative to one another in the manner of a differential gearbox and which have a simple design together with a small volume.

This aim is achieved with the characterizing features of the first claim. Advantageous embodiments are disclosed in the subclaims.

The eccentric differential gearbox has two output elements which are rotatable relative to one another, wherein according to the invention, an eccentric gear which is drivable by means of an input drive element and has a first longitudinal axis comprises two external tooth sets arranged one behind the other along the first longitudinal axis and the pitch diameter of the first external tooth set is greater than the pitch diameter of the second external tooth set, and a first output element which has a first internal tooth set corresponding to the first external tooth set is associated with the first external tooth set of the eccentric gear, and a second output element which has a second internal tooth set corresponding to the second external tooth set is associated with the second external tooth set of the eccentric gear, and wherein the first and second output elements are rotatably mounted on a common second longitudinal axis and the first longitudinal axis of the eccentric gear is arranged eccentrically to the second longitudinal axis and the eccentric gear which is driven by the input drive element partially meshes with the external tooth set thereof in the internal tooth set of the output elements and the external and internal tooth sets are configured such that on rotation of the eccentric gear, the first output element and the second output element perform a rotary movement relative to one another, wherein the rotary speed of the outputs depends on the torque applied.

The eccentric gear, the first output element and the second output element are all rotatable relative to one another. If one of the output elements is held in position, then the other output element rotates faster depending on the gearing ratio. The eccentric gear is preferably configured as a hollow gear in the internal diameter of which an input element engages. The input element can be, for example, an eccentric shaft or a circulating wheel which is fastened to the rotating input drive element and rolls over the inner diameter of the eccentric gear.

Driving of the input drive element is preferably performed with an electric input drive motor.

The first output element is preferably configured in the form of a first hollow gear and the second output element is preferably configured in the form of a second hollow gear. It is possible to bring the first output element into active engagement with a first anti-roll bar member and to bring the second output element into active engagement with a second anti-roll bar member of an anti-roll bar of a vehicle, so that on relative rotation of the two output elements, the two anti-roll bar halves are also rotated relative to one another, so that vehicle movements can be equalized. The relevant input drive can also be arranged on the side of the first output element or of the second output element.

It is possible for the first output element to be connected to a housing of an anti-roll bar or to form the housing of an anti-roll bar or for the first internal tooth set to be provided on the internal diameter of the housing. The first anti-roll bar member is therefore firmly coupled to the housing or is provided within the housing. In this case, the housing-side end of the second anti-roll bar member is connected to the second output element. The electric motor is firmly mounted within the housing. If now the housing rotates and thus also the first output element, which is connected to the first anti-roll bar member, relative to the second output element, to which the second anti-roll bar member is attached, then the two anti-roll bar halves also rotate relative to one another.

Alternatively, the motor can be firmly mounted within a housing and the first output element can be directly connected to the first anti-roll bar half and the second output element can be directly connected to the second anti-roll bar half. The housing is then mounted in twist-proof manner to the bodywork. In this case, also, the anti-roll bar halves fastened to the output elements of the eccentric differential gearbox rotate relative to one another, according to the relative rotation of the output elements.

Rather than generating a relative rotation movement between two anti-roll bar halves, it is also possible to connect two other components which are to be rotated/pivoted relative to one another with the two output elements.

According to another embodiment of the invention, it is also possible to use the relative rotation of the first and second output elements to produce a stroke movement of a component. In this case, the eccentric differential gearbox has first coupling elements mounted in articulated manner on the first output element and second coupling elements mounted in articulated manner on the second output element, wherein the first and second coupling elements have inclination angles which oppose one another and are fastened in articulated manner to the component at the other ends of said coupling elements, such that with a rotary movement of the first and second output elements relative to one another, the angular positions of the first and second coupling elements are changed and the component is thereby caused to carry out a stroke movement along the longitudinal axis of the output elements.

The coupling elements are preferably configured in the form of ball bars that are mounted in articulated manner at both ends.

For this purpose, the eccentric differential gearbox has, at a first end side of the first output element, a first bearing element with first mountings for the first coupling elements and, at a first end side of the second output element, a second bearing element with second mountings for the second coupling elements.

Preferably, the first and second mountings are provided in a common plane transversely to the second longitudinal axis.

The first mountings are also arranged on a first larger pitch circle and the second mountings are arranged on a second smaller pitch circle.

The first and second coupling elements on the component are mounted, at the opposing ends thereof, on a common or different pitch circles. In the latter case, the first coupling elements are arranged on the component on a third pitch circle and the second coupling elements are arranged on the component on a fourth pitch circle, wherein the third pitch circle is preferably larger than the fourth pitch circle.

Despite a rotary movement of the two output elements, the component connected to the eccentric differential gearbox via the coupling elements essentially performs only a stroke movement. The solution can therefore be used to generate an axial stroke movement of components. For example, the component can be a spring mounting of a spring or can act on a mounting of a spring, such that the spring mounting is displaceable along a longitudinal axis of a spring.

The solution according to the invention provides an eccentric differential gearbox with two output elements forming a differential gearing arrangement, which operates unexpectedly fast and dynamically. By providing the toothed gear pairings with slightly different numbers of teeth (first external tooth set of the eccentric gear and first internal tooth set of the first output as well as the second external tooth set of the eccentric gear and the second internal tooth set of the second output), a high transmission ratio can be realized, so that large moments can be transmitted.

In particular, the use in vehicles (e.g., in anti-roll bars for cancelling out rolling and pitching movements or for adjusting spring mountings or supports along the spring longitudinal axis for adjusting the characteristics of vehicle suspension to improve the driving dynamics) ensures rapid, dynamic control and adjustment during travel. The invention will now be described in greater detail on the basis of exemplary embodiments and the associated drawings, in which:

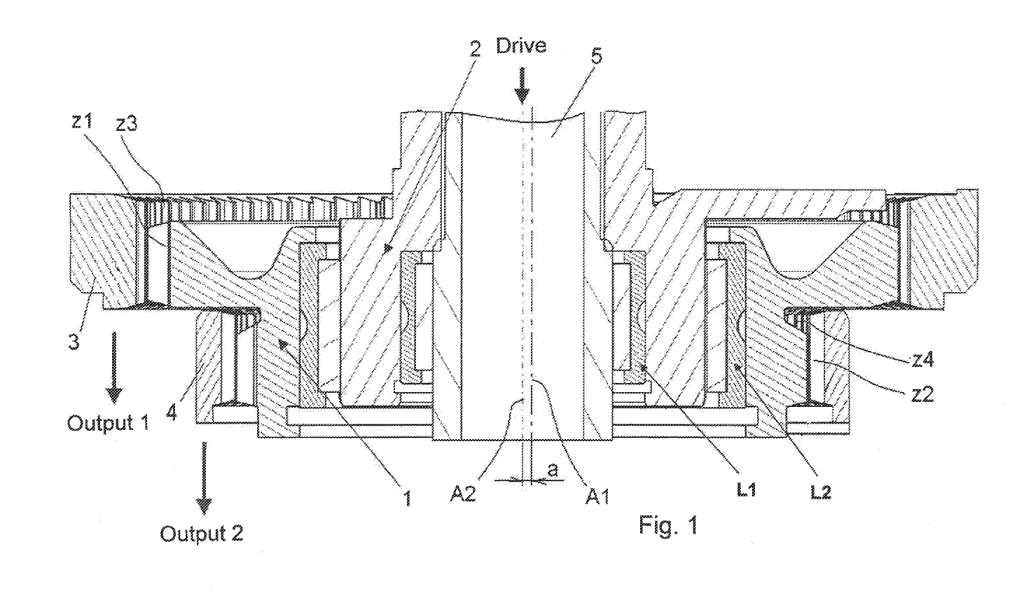

FIG. 1 is a longitudinal section through an eccentric differential gearbox,

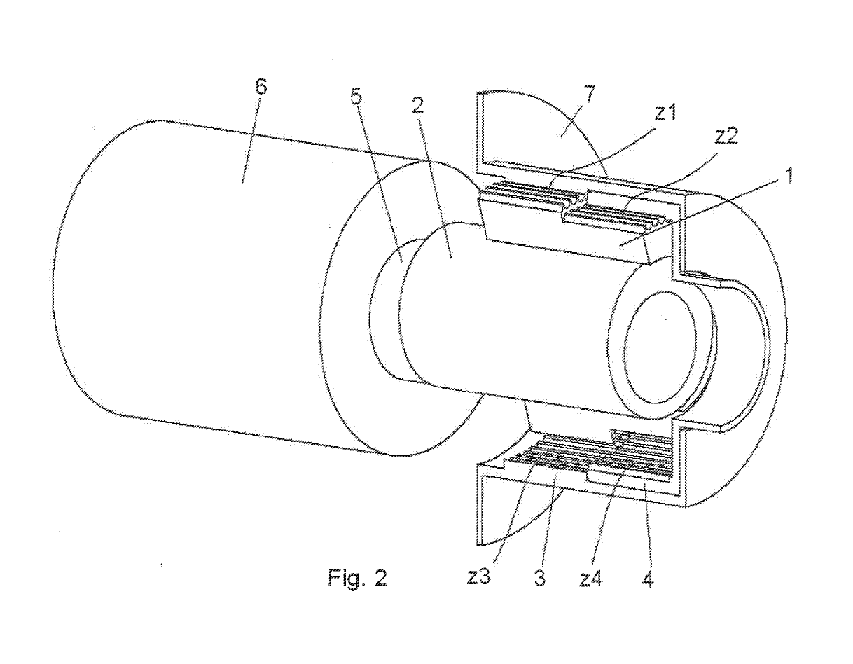

FIG. 2 is a schematic partial longitudinal section through an eccentric differential gearbox,

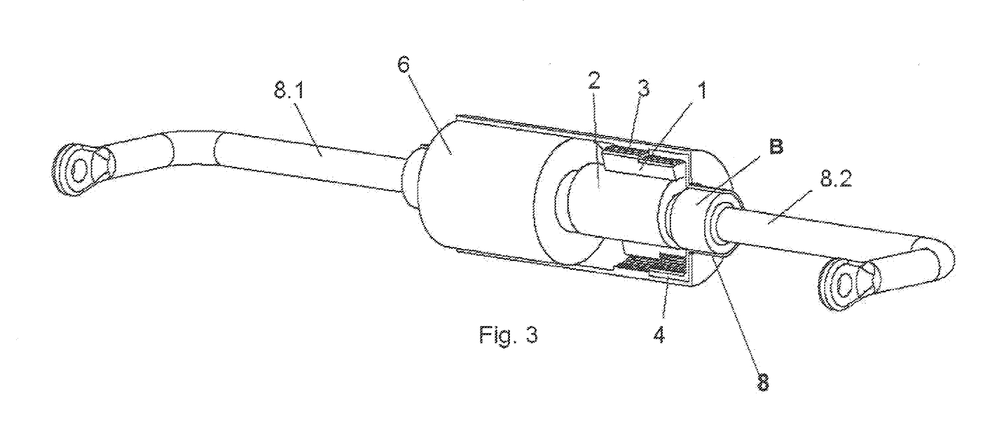

FIG. 3 is a schematic partial longitudinal section through an anti-roll bar using an eccentric differential gearbox,

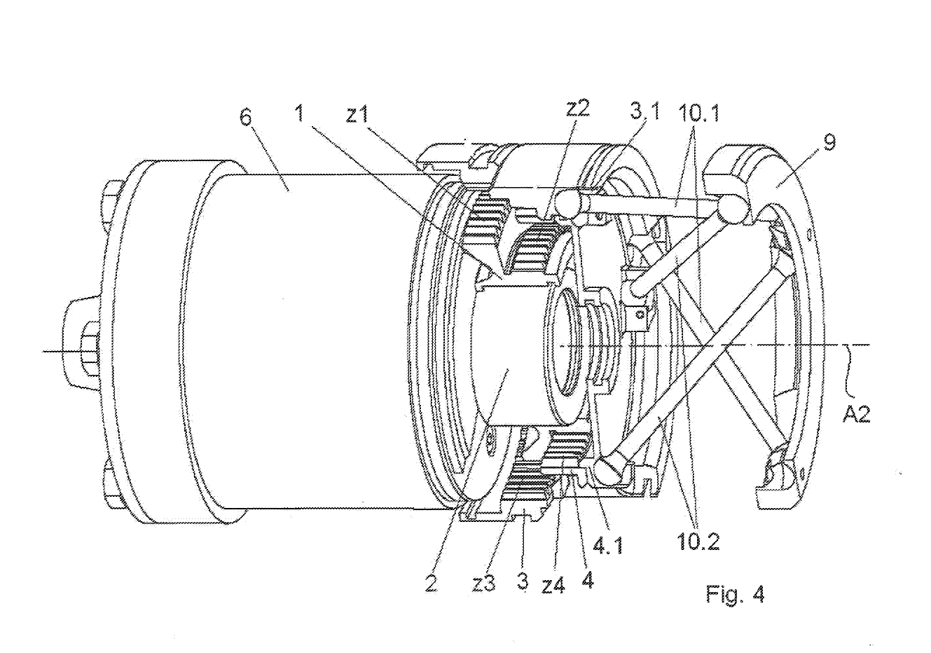

FIG. 4 is a schematic partial longitudinal section through an eccentric differential gearbox using coupling elements for axial displacement of a component,

FIG. 5 is a plan view of an eccentric differential gearbox with a circulating roller as the input drive,

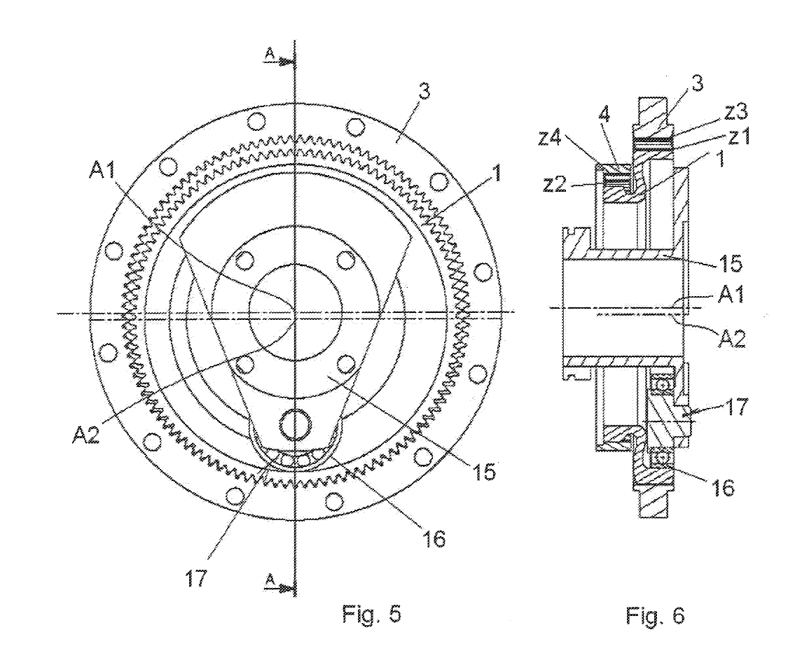

FIG. 6 is the section A-A of FIG. 5.

FIG. 1 shows a longitudinal section through an eccentric differential gearbox. Said gearbox has an eccentric gear 1 with a first external tooth set z1 and a second external tooth set z2. The pitch diameter of the first external tooth set z1 is larger than the pitch diameter of the second external tooth set z2. The eccentric gear 1 has a first longitudinal axis A1 and is driven by an input drive element configured in the form of an eccentric shaft 2 which engages in the eccentric gear 1. Situated in the eccentric shaft 2, which is hollow in this case, is a fixed axle 5 for mounting the eccentric shaft 2. The eccentric shaft 2 is driven, for example, by an electric input drive motor and is supported via a first bearing L1 on the axle 5 and on the eccentric gear 1 via a second bearing L2 on the eccentric shaft 2, wherein the first and second bearings L1, L2 are preferably configured as needle bearings.

A first output element 3 (1^{st} output) is also provided which is configured as a hollow gear and comprises a first internal tooth set z3, which corresponds to the first external tooth set of the eccentric gear 1. A second output element 4 (2^{nd} output) with a second internal tooth set z4 corresponding to the second external tooth set z2 is associated with the second external tooth set z2 of the eccentric gear 1. The first and second output element 3, 4 have a common second longitudinal axis A2. The first longitudinal axis A1 of the eccentric gear 1 is offset by a quantity a from the second longitudinal axis A2. The pitch diameter of the first external tooth set z1 is smaller than the pitch diameter of the first external tooth set z3 by this quantity a and the pitch diameter of the second external tooth set z2 is smaller than the pitch diameter of the second external tooth set z4 by this amount. On rotation of the eccentric shaft 2, the eccentric gear is thereby brought only partially with the external tooth sets z1, z2 thereof into engagement with the corresponding internal tooth sets z3, z4 of the two hollow gears/output elements 3, 4. In the longitudinal section shown in FIG. 1, on the left-hand side the tooth sets are not in engagement, whereas, on the right-hand side the first external tooth set z1 partly meshes with the first internal tooth set z3 and the second external tooth set z2 partly meshes with the second internal tooth set z4. The external and internal tooth sets z1/z3 and z2/z4 are configured such that, on rotation of the eccentric gear 1, the first output element 3 and the second output element 4 perform a rotary movement, relative to the input drive, in the form of the eccentric shaft 2 and relative to one another. If no output element 3, 4 is non-rotatably held, the rotary speed of the two output elements 3, 4 depends on the torque applied. If, for example, the first output element 3 is non-rotatably held, the eccentric gear 1 still runs therein and the second output element 4 rotates dependent only on the gearing ratio which is determined by the tooth set pairings z1/z3 and z2/z4. Similarly, the first output element 3 continues to turn depending on the tooth set pairings z1/z3 and z2/z4 if the second output element 4 is non-rotatably held. With this novel design according to the invention, an eccentric differential gearbox is provided which has a simple, space-saving construction and with which the rotary speeds of the output elements 3, 4 are automatically determined depending on the input torque and on the torques acting on the first and/or second output elements 3, 4, which in turn depend on the selected gearing ratios.

The schematic partial longitudinal section through an eccentric differential gearbox is shown in FIG. 2. The input drive motor 6 drives the eccentric shaft 2 which, in this case, is configured hollow and therefore also the eccentric gear 1.

The eccentric gear 1 partially meshes with the first external tooth set z1 thereof in the first internal tooth set z3 of the first output element 3 and partially with the second external tooth set z2 thereof in the second internal tooth set z4 of the second output element 4. The first output element 3 encircles the second output element 4 and has a fastening flange 7.

The schematic partial longitudinal section of an anti-roll bar making use of an eccentric differential gearbox is shown in FIG. 3. The first output element 3 is constructed in the manner of a housing and surrounds the input drive motor 6 and the entire gearbox and is connected to a first anti-roll bar member 8.1. The second output element 4 is connected to a bushing B which, in turn, is firmly connected to the second anti-roll bar member 8.2. The input drive motor 6 is firmly mounted in the housing (output element 3).

On a relative rotation between the first and second output elements 3, 4, the ends of the anti-roll bar members 8.1, 8.2 connected therewith are rotated relative to one another.

FIG. 4 shows the schematic partial longitudinal section through an eccentric differential gearbox with a component 9 which is axially displaceable making use of first coupling elements 10.1 in the form of ball bars which are mounted in articulated manner with their first ends on the first output element 3 with a first (outer) spherical ring 3.1, and second coupling elements 10.2 in the form of ball rods which are mounted in articulated manner with the second ends thereof on the second output element 4 with a second (inner) spherical ring 4.1. The coupling elements 10.1 and the coupling elements 10.2 have opposing inclinations in relation to the longitudinal axis A2. Situated in the first and second output elements 3, 4 is an eccentric gear 1 which is driven by an eccentric shaft 2 by means of the input drive motor 6. The first external tooth set z1 of the eccentric gear 1 meshes with the first internal tooth set z3 of the first output element 3 and the second external tooth set z2 of the eccentric gear 1 meshes with the second internal tooth set z4 of the second output element 4. The tooth set pairings z1/z3 and z2/z4 are arranged axially behind one another, wherein the pairing z1/z3 has a larger pitch diameter than the pairing z2/z4. The first output element 3 encircles the second output element 4, so that the end sides of the output elements in the direction toward the component 9 are arranged approximately in one plane transversely to the longitudinal axis A2 and therefore the ball bar ends (coupling elements 10.1 and 10.2) attached thereto also lie in one plane. The other ends of the coupling elements 10.1 and 10.2 are pivotably mounted with the balls thereof on the component 9.

On a relative rotation of the output elements 3, 4, the angular positions of the coupling elements 10.1, 10.2 are changed so that the component 9 performs an axial movement if said component is mounted non-twistably and axially movable.

The rotation angle between the two output elements 3, 4 is determined by the freedom of movement of the ball bars. By means of forward and backward rotation of the two output elements 3, 4 relative to one another, the component 9 performs an axial movement. The component 9 can be, for example, a pressure element for adjusting a spring mounting of a vehicle spring.

FIG. 5 shows a plan view and FIG. 6 shows the section A-A of FIG. 6 of an eccentric differential gearbox with a circulating roller as the input drive. The eccentric gear 1 is configured as a hollow gear. An input drive element 15 which comprises a circulating roller 16 which rolls along the internal diameter of the eccentric gear 1 engages in said eccentric gear. In this case, the circulating roller 16 is the outer ring of a ball bearing 17.

The longitudinal axis of the input drive element 15 aligns with the second longitudinal axis A2 of the first output element 3 and of the second output element 4. The first longitudinal axis A1 of the eccentric gear 1 is arranged eccentrically thereto.

On rotation of the input drive element 15, the eccentric gear 1 performs a rotation movement and the first longitudinal axis A1 thereof rotates about the second longitudinal axis A2, so that said eccentric gear 1 partially meshes with the first external tooth set z1 thereof in the first internal tooth set z3 of the first output element and with the second output tooth set z2 thereof in the second internal tooth set z4 of the second output element.

### REFERENCE SIGNS

1 Eccentric gear
2 Eccentric shaft
3 First output element
3.1 First spherical ring
4 Second output element
4.1 Second spherical ring
5 Axle
6 Input drive motor
7 Fastening flange
8.1 First anti-roll bar element
8.1 Second anti-roll bar element
9 Component
10.1 First coupling element
10.2 Second coupling element
15 Input drive element
16 Circulating roller
17 Ball bearing
A1 First longitudinal axis
A2 Second longitudinal axis
a Offset between first and second longitudinal axis A1, A2
B Bushing
L1 First bearing
L2 Second bearing
z1 First external tooth set
z2 Second external tooth set
z3 First internal tooth set
z4 Second internal tooth set

1-14. (canceled)

15. An eccentric differential gearbox having two output elements which are rotatable relative to one another, said gearbox comprising:
an eccentric gear configured as a hollow gear which is drivable by an input drive element and which comprises first and second external tooth sets arranged one behind the other along a first longitudinal axis of said eccentric gear, said external tooth sets having different pitch diameters;
a first output element in the form of a first hollow gear which has a first internal tooth set corresponding to the first external tooth set and which is associated with the first external tooth set of the eccentric gear, and
a second output element in the form of a second hollow gear which has a second internal tooth set corresponding to the second external tooth set and which is associated with the second external tooth set of the eccentric gear;
wherein:
the first and second output elements are arranged opposite the input drive element on the output side and are rotatably mounted on a common second longitudinal axis which is arranged eccentrically to the first longitudinal axis of the eccentric gear;
the eccentric gear which is driven by the input drive element partially meshes with the external tooth sets thereof in the internal tooth sets of the output elements such that upon rotation of the eccentric gear, the first output element and the second output element execute a rotary movement relative to the input drive element and relative to one another, and
the rotary speed of the output elements depends on the torque applied.

16. The eccentric differential gearbox as claimed in claim 1, wherein an eccentric shaft engages in the internal diameter of the eccentric gear.

17. The eccentric differential gearbox as claimed in claim 1, wherein a circulating roller lies partially on the internal diameter of the eccentric gear, said circulating roller being fastened to the input drive element and upon rotation of the input drive element rolling around the internal diameter of the eccentric gear.

18. The eccentric differential gearbox as claimed in claim 1, wherein the first output element is in active engagement with a first anti-roll bar member, and the second output element is in active engagement with a second anti-roil bar member of an anti-roll bar of a vehicle.

19. The eccentric differential gearbox as claimed in claim 18, wherein
the first output element is connected to a housing of an anti-roll bar or forms a housing of an anti-roll bar;
the first anti-roll bar member is firmly coupled to the housing; and
the housing-side end of the second anti-roll bar member is connected to the second output element.

20. The eccentric differential gearbox as claimed in claim 1, wherein:
first coupling elements mounted in articulated manner are in active engagement with the first output element;
second coupling elements mounted in articulated manner are in active engagement with the second output element;
said first and second coupling elements have inclination angles which oppose one another and are mounted in articulated manner on a component at the other ends of said coupling elements, such that upon rotary movement of the first and second output elements relative to one another, the angular positions of the first and second coupling elements are changed, and the component is thereby caused to execute a stroke movement along the second longitudinal axis of the output elements.

21. The eccentric differential gearbox as claimed in claim 20, wherein the coupling elements are configured in the form of ball bars.

22. The eccentric differential gearbox as claimed in claim 20, wherein:
at a first end side of the first output element, a first bearing element is provided having first mountings for the first coupling elements, and
at a first end side of the second output element, a second bearing element is provided having second mountings for the second coupling elements.

23. The eccentric differential gearbox as claimed in claim 22, wherein the first and second mountings are provided in a common plane transversely to the second longitudinal axis.

24. The eccentric differential gearbox as claimed in claim 22, wherein:
the first mountings are arranged on a first, larger pitch circle, and
the second mountings are arranged on a second, smaller pitch circle.

25. The eccentric differential gearbox as claimed in claim 20, wherein the first and second coupling elements are mounted on said component on a common or different pitch circles.

26. The eccentric differential gearbox as claimed in claim 25, wherein:
the first coupling elements are arranged on the component on a third pitch circle, and
the second coupling elements are arranged on the component on a fourth pitch circle, wherein the third pitch circle is larger than the fourth pitch circle.

27. The eccentric differential gearbox as claimed in claim 20, wherein the component is a mounting of a spring or acts on a spring mounting such that the spring mounting is displaceable along a longitudinal axis of a spring.

28. The eccentric differential gearbox as claimed, in claim 15, wherein the input drive is arranged on the side of the first output element or of the second output element.
